(19) United States
(12) Patent Application Publication
(10) Pub. No.: US 2023/0302313 A1
(43) Pub. Date: Sep. 28, 2023

(54) Fire Barrier Device

(71) Applicant: Zachary Wisecup, Glenwood, IA (US)

(72) Inventor: Zachary Wisecup, Glenwood, IA (US)

(21) Appl. No.: 18/149,305

(22) Filed: Jan. 3, 2023

Related U.S. Application Data
(60) Provisional application No. 63/322,809, filed on Mar. 23, 2022.

(51) Int. Cl. A62C 2/06; F16L 5/04

(52) U.S. Cl. CPC A62C 2/065; F16L 5/04

(57) ABSTRACT

A fire reactive barrier device for protecting a fire wall system penetrated by a pipe or a conduit. A cylindrical sleeve is closed around and encapsulates a portion of the pipe or conduit penetrating the wall system. A flange extends externally along the outside surface of the wall to fully cover a penetration from the pipe or conduit. An intumescent component located within the sleeve expands on exposure to elevated temperatures filling any gap or space in the wall created by the pipe or conduit melting. The intumescent component may also penetrate holes in the sleeve to further expand out into the interior wall space. A system for protecting a fire wall system penetrated by a pipe or a conduit employs a second fire reactive barrier device positional on the opposite side of the fire wall system.

### CROSS-REFERENCE TO RELATED APPLICATION

The present application claims priority to, and the benefit of, U.S. Provisional Application No. 63/322,809, which was filed on Mar. 23, 2022, and is incorporated herein by reference in its entirety.

### FIELD OF THE INVENTION

The present invention generally relates to fire safety devices. More specifically, the present invention relates to a device and system for use in a wall structure to act as a fire barrier around a penetration from a conduit or pipe. Accordingly, the present specification makes specific reference thereto. However, it is to be appreciated that aspects of the present invention are also equally amenable to other like applications, devices and methods of manufacture.

### BACKGROUND

Structure fires are a daily occurrence throughout the United States. These building fires can occur from numerous causes. Smoke detectors are credited with saving the many lives as fires often occur when no one is present at the onset of the fire. Unfortunately, smoke detectors are only useful to alert occupants and do nothing to stop the spread of the fire throughout the structure. Unchecked fire spread can quickly and easily destroy a structure despite intervention from the fire service.

Toxic gases and other hazardous substances combine to produce serious dangers that quickly pervade any area of the structure that is not sealed from the other areas. Many furnishings are constructed from synthetic materials that emit these harmful, toxic, and deadly gases when they burn. Some of the main byproducts of fire gases are lethal concentrations of carbon monoxide and hydrogen cyanide gases. These gases are odorless, colorless, and tasteless making them difficult to detect, yet no less deadly.

When a fire occurs, there is often little time to react. If left unchecked, these fires grow quickly leaving the occupants in great danger. Many occupants may be unaware of the danger until it is too late. Occupants in nursing homes and hospitals are at even greater risk as they are often unable to self-rescue. Most fire preplans attempt to protect these occupants by closing off units and sections for sheltering in place.

The sheltering in place strategy can buy some time until rescuers can complete evacuations if the required fire protections are in place and correctly installed. Unfortunately, these buildings are constantly being remodeled and retrofitted. Contractors and remodelers are often unaware of the fire code requirements and inspections by qualified inspectors are not always completed or timely leaving occupants at risk. A fire wall is essentially useless if there are penetrations in place that cannot stop or slow the spread of fire. These later created at risk areas may take years to discover, if discovered at all after secondary construction.

Commercial and high life hazard locations, such as hospitals, schools, hotels, nursing homes, and other places of assembly are required by fire code to have even greater protection than only smoke detectors as the danger is even greater. These structures often have sprinkler systems installed. The sprinkler hopefully dispense water automatically in the event of a fire. However, they are only beneficial in areas that are piped with sprinkler heads. Many areas of these structures are left unprotected. Further sprinklers are costly and difficult to retrofit into existing structures.

As a result, fire codes typically require more passive protections including fire rated doors and wall systems. Fire-stopping is a form of passive fire protection that is used to seal and protect around openings and between joints in a fire-resistance-rated wall or floor assembly. Firestops are designed to maintain the fire-resistance rating of a wall or floor assembly intended to impede or slow the spread of fire and smoke. Firestops prevent unprotected horizontal and vertical penetrations in a fire-resistance-rated wall or floor assembly from creating a route by which fire and smoke can spread that would otherwise have been fire resisting construction, such as where a pipe passes through a firewall. Fire stopping is also used to seal around gaps between fire resisting constructions, such as the gap between a wall and the floor above, for construction to form a complete barrier to fire and smoke spread.

An intumescent material is a substance that expands when exposed to heat leading to an increase in volume and decrease in density in the material. Intumescent materials are typically used in passive fire protection to comply with the fire codes. Intumescent firestop sealants and caulks are applied to gaps and voids made from penetrants through fire-rated walls. These materials will stop the passage of smoke and flame through these voids during the event of a fire. The intumescent material will expand and harden when the fire caulk hits an elevated temperature caused by a fire. The intumescent char will block and seal any gaps or openings and block smoke or other toxic fumes from passing through.

Inconsistencies in firestop system installation can lead to firestop materials not properly activating during a fire. It can be difficult for people to understand how to install firestop materials if inexperienced in doing so. Cleaning up sticky sealants can be frustrating and end up staining clothing. Further, lack of follow-up code inspection leaves commercial, manufacturing, educational, and healthcare facilities vulnerable.

Therefore, there exists a long felt need in the art for a better way to protect commercial and high life hazard structures in the event of a fire. There is also a need in the art for an improved fire barrier for use during remodeling. Further, there is a need in the art for a fire stopping solution that eliminates the need for an after applied sealant and any potential installation errors of the sealant. There is a need in the art for a fire barrier device for use with pipes and conduit that penetrate wall and ceiling systems. Finally, there is a need in the art for a way to improve safety and efficiency when installing pipes and conduits within an existing or new firewall.

In this manner, the improved fire barrier device of the present invention accomplishes all of the foregoing objectives, thereby providing an easy solution for protecting pipes or conduits installed within a firewall. A primary feature of the present invention is a device that wraps around pipes or conduits installed within a firewall. The device releases a material that expands during a fire, filling the void in the firestop should the conduits melt. The device eliminates the need for an after-applied sealant and any potential installation errors of the sealant. Finally, the improved fire barrier device of the present invention is capable of improving safety and efficiency when installing pipes and conduits within a firewall.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a fire barrier device of the present invention for protecting a wall system penetrated by a conduit. The fire barrier device comprises a conduit retaining component, a flange component, and an intumescent component. The conduit retaining component is configured to be positioned around and encapsulate a portion of the conduit within the wall system.

The conduit retaining component comprises a cylindrical body and a hinge running a length of the cylindrical body between a flange end and a distal end of the cylindrical body. The cylindrical body comprises a plurality of perforations penetrating an interior surface through an exterior surface of the cylindrical body.

The cylindrical body further comprises a first half and a second half. The first and second halves are connected along the hinge. The first and second halves open along the hinge to receive the conduit. The first half comprises a receiving element positioned opposite the hinge, and the second half comprises an attachment element positioned opposite the hinge. The attachment element mates with the receiving element to secure the first and second halves around the conduit.

The flange component is attached to the flange end of the cylindrical body of the conduit retaining component. The flange component comprises a first half and a second half. The first half of the flange component comprises an overlap portion configured to slide behind an overlap portion of the second half of the flange component when the first and second halves of the cylindrical body are opened along the hinge.

The first half of the flange component further comprises an attachment element for mating with a receiving element of the second half of the flange component. The flange component further comprises a plurality of attachment holes. The fire barrier device may further comprise a plurality of flange attachment fasteners. The plurality of flange attachment fasteners penetrate the plurality of attachment holes to secure the flange component to an exterior surface of the wall system.

The intumescent component is positioned along the interior surface of the cylindrical body. The intumescent component expands outward upon exposure to heat and penetrates the plurality of perforations. The intumescent component further expands inward upon exposure to heat to fill a void created by the conduit when melted. The intumescent component may also be positioned along an exterior surface of the cylindrical body or along an interior surface of the flange component.

The subject matter disclosed and claimed herein, in one embodiment thereof, comprises a fire barrier system of the present invention for protecting a wall system penetrated by a conduit. The fire barrier system comprises a first fire barrier device and a second fire barrier device. The first and second fire barrier devices are each constructed identically to the fire barrier device of the previous embodiment. The first fire barrier device is positional on one side of the wall system and the second fire barrier device is positional on an opposing side of the wall system so that the conduit is completely encapsulated within the wall system.

The first barrier device comprises a perforated conduit retaining component, a flange component, and an intumescent component. The perforated conduit retaining component encapsulates a portion of the conduit within the wall system on a first side of the wall system.

The second barrier device comprises a second perforated conduit retaining component, a second flange component, and a second intumescent component. The second perforated conduit retaining component encapsulates a portion of the conduit within the wall system on an opposite side of the wall system. The perforated conduit retaining components abut within the wall system to completely encapsulate the conduit within the wall system. Each intumescent component is configured to penetrate the respective perforated conduit retaining component when exposed to heat and to fill a void created by the conduit when melted.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a fire barrier device of the present invention for protecting a wall system penetrated by a conduit in in accordance with the disclosed architecture.

FIG. 2 illustrates a cut away view of the fire barrier device of the present invention for protecting a wall system penetrated by a conduit in place in the wall system in accordance with the disclosed architecture.

FIG. 3 illustrates a perspective view of the fire barrier device of the present invention for protecting a wall system penetrated by a conduit in accordance with the disclosed architecture.

FIG. 4 illustrates a perspective view of a conduit retaining component and an intumescent component of the fire barrier device of the present invention for protecting a wall system penetrated by a conduit in accordance with the disclosed architecture.

FIG. 5 illustrates a front view of a flange component of the fire barrier device of the present invention for protecting a wall system penetrated by a conduit in accordance with the disclosed architecture.

FIG. 6 illustrates a rear view of the flange component of the fire barrier device of the present invention for protecting a wall system penetrated by a conduit in accordance with the disclosed architecture.

FIG. 7 illustrates side cutaway view of the flange component of the fire barrier device of the present invention for protecting a wall system penetrated by a conduit in accordance with the disclosed architecture.

FIG. 8 illustrates a cut away view of a fire barrier system of the present invention for protecting a wall system penetrated by a conduit in place in a wall system in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a device that will assist with sealing pipes, conduits, or other penetrations within a firewall to prevent the spread of fire. The device is comprised of a two-piece wrap-around assembly with a hinge on one side and a clip on the other to attach around pipes or conduits installed within a firewall. In one embodiment, there would be about 1.5 to 2 inches of the device depressed into the wall with the top resting on the wall itself, although it can be longer or shorter as necessary. The device may also be mechanically attached to the wall with screws to prevent it from moving after placement. The portion of the device in the wall would contain intumescent material that would expand and fill the gap created by the melted pipe in the event of a fire.

The device releases an intumescent material that expands when exposed to high heat or a fire, filling the void in the firestop should the pipes melt. The device may be held in place via the friction of the pipe or conduit in tandem with being screwed into the wall or floor. The present invention would eliminate the need for a sealant material and potential errors of installation of such sealant, thereby improving safety and efficiency when installing pipes and conduits within a firewall.

The device is designed to protect a fire wall system penetrated by a pipe or a conduit. A sleeve is closed around and encapsulates a portion of the pipe or conduit penetrating the wall system. A flange extends externally along the wall to fully cover a penetration for the pipe or conduit. An intumescent component located within the sleeve expands on exposure to high heat or fire filling any gap or space in the wall created by the pipe or conduit melting. The intumescent component may also penetrate gaps in the sleeve to further expand out into the interior wall space. A system for protecting a fire wall system penetrated by a pipe or a conduit employs a second fire reactive barrier device positional on the opposite side of the fire wall system.

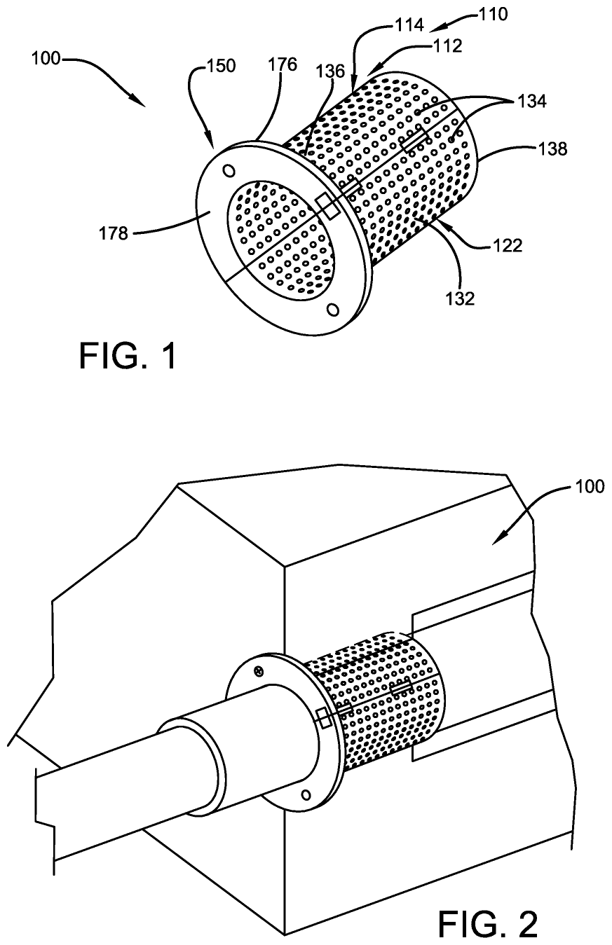

Referring initially to the drawings, FIGS. 1-7 illustrates a fire barrier device 100. The fire barrier device 100 is configured to protect a wall system penetrated by a conduit as illustrated in FIG. 2. The conduit may be any penetrating object such as, but not limited to, piping, plastic conduit, wiring, sleeve, or the like. The wall system may be any barrier such as, but not limited to, a wall, fire wall, cavity wall, partition, ceiling, floor, barrier, or the like that is used in building construction. A typical wall system includes an interior wall space surrounded by an inward facing wall and an outward facing wall. An intact wall system with no penetrations usually has at least some fire resistance. Any penetration to the wall system allow the passage or heat and smoke.

As illustrated in FIGS. 1-4, the fire barrier device 100 comprises a conduit retaining component 110, a flange component 150, and an intumescent component 180. The conduit retaining component 110 is configured to be positioned around and encapsulate a portion of the conduit within the wall system. The conduit component 110 is typically metal in construction, although a plastic construction capable of passing fire testing is contemplated as well. The conduit component 110 is sized to partially extend into the wall system without penetrating the opposite wall.

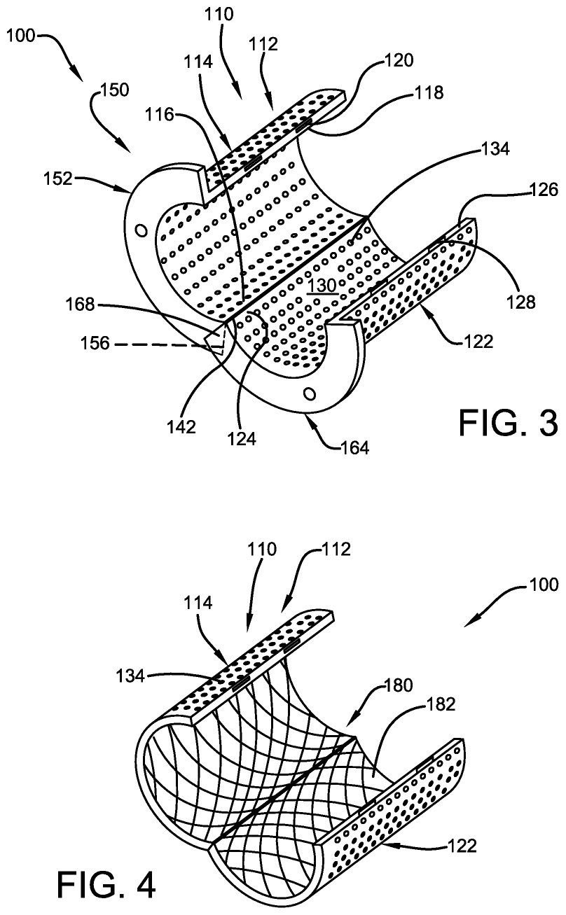

As illustrated in FIG. 3, the conduit retaining component 110 comprises a cylindrical body 112 and a hinge 142. The cylindrical body 112 comprises a flange end 136 and a distal end 138. The flange end 136 attached to the flange component 150 and the distal end 138 extends into an interior of the wall system. The hinge 142 extends a length of the cylindrical body 112 between the flange end 136 and a distal end 138. The hinge 142 is typically a metal hinge of any desired size or shape. A low profile hinge 142 would be desirable for tighter openings.

The cylindrical body 112 further comprises an interior surface 130 and an exterior surface 132. The interior surface 130 surrounds the conduit. The cylindrical body 112 further comprises a plurality of perforations 134. The plurality of perforations 134 penetrate the interior surface 130 through an exterior surface 132 of the cylindrical body 112. The plurality of perforations 134 are shaped and sized to permit passage of an intumescent material when exposed to heat. In one example, the perforations 134 could take up most of the area of the cylindrical body 112. Large rectangular openings that leave about a quarter inch of metal all around them are contemplated.

The cylindrical body 112 further comprises a first half 114 and a second half 122. The first half 114 comprises a hinge side 116 and an opposing side 118. The second half 122 is identically shaped comprising a hinge side 124 and an opposing side 126. The first and second halves 114 and 122 are connected along the hinge 142 at the hinge sides 116 and 124 The opposing sides 118 and 126 of the first and second halves 114 and 122 open like a clam shell along the hinge 142 to receive the conduit. Then the opposing sides 118 and 126 are then closed together to encapsulate the conduit.

The first half 114 further comprises a receiving element 120. The receiving element 120 is positioned adjacent to the opposing side 118 of the first half 114. The second half 122 comprises an attachment element 128. The attachment element 128 is positioned adjacent to the opposing side 126 of the second half 122. The attachment element 128 mates with the receiving element 120 to secure the first and second halves 114 and 122 around the conduit. The attachment element 128 may be a mechanical fastener, a strap, a tab, or any similar means of connecting two components.

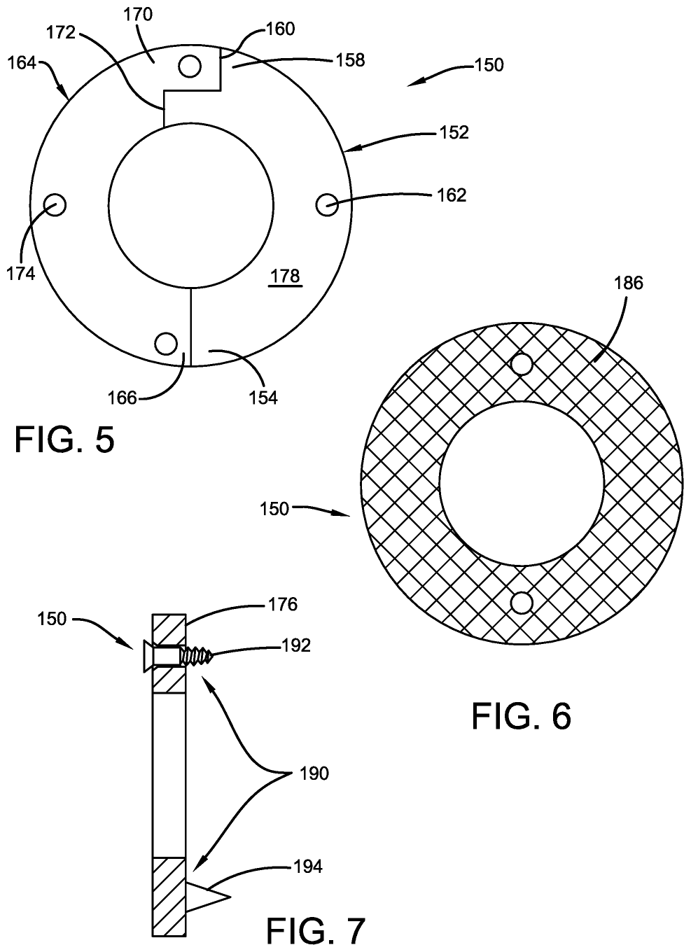

As illustrated in FIGS. 1 and 3, the flange component 150 is attached to the flange end 136 of the cylindrical body 112 of the conduit retaining component 110. As illustrated in FIGS. 5-7, the flange component 150 comprises an interior surface 176 and an exterior surface 178. The interior surface 176 is positioned against and abuts the outer wall of the wall system when the fire barrier device 100 is in position protecting the conduit.

As illustrated in FIGS. 3 and 5-7, the flange component 150 further comprises a first half 152 and a second half 164. The first half 152 of the flange component 150 comprises a hinge end 154 and an opposing end 158. The hinge end 154 comprises an overlap portion 156. The second half 164 of the flange component 150 similarly comprises a hinge end 166 and an opposing end 170. The hinge end 166 of the second half 164 similarly comprises an overlap portion 168. The overlap portion 156 of the first half 152 is configured to slide behind the overlap portion 168 of the second half 164 when the first and second halves 114 and 122 of the cylindrical body 112 are opened along the hinge 142.

The first half 152 of the flange component 150 further comprises an attachment element 160. The second half 152 of the flange component 150 further comprises a receiving element 172. The attachment element 160 is configured to mate with the receiving element 172 to connect the first and second halves 152 and 164 when the fire barrier device 100 is in position protecting the conduit. The attachment element 160 may be a mechanical fastener, a strap, a tab, or any similar means of connecting two components.

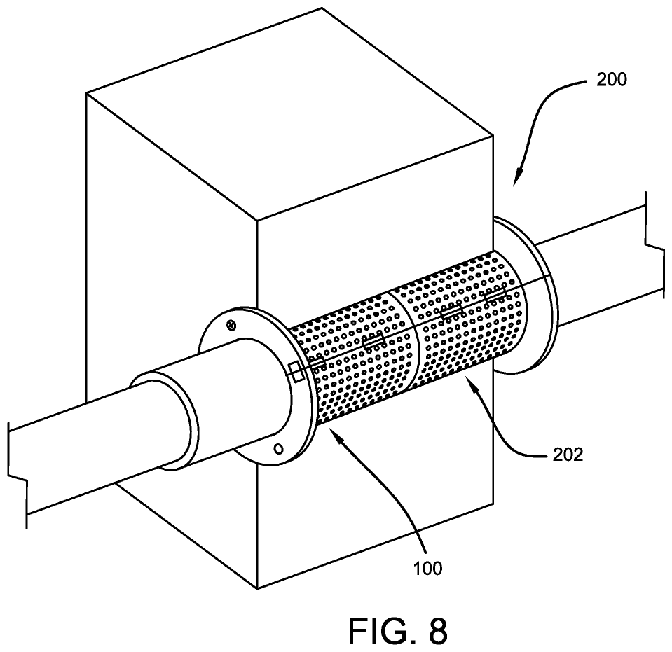

The flange component 150 further comprises a plurality of attachment holes 162 and 174. The plurality of attachment holes 162 and 174 may be positioned anywhere around the flange component 150. As illustrated in FIG. 7, the fire barrier device 100 may further comprise a plurality of flange attachment fasteners 190. The plurality of flange attachment fasteners 190 can penetrate the plurality of attachment holes 162 and 174 to secure the flange component 150 to an exterior surface of the wall system. The plurality of flange attachment fasteners 190 may comprise a plurality of screws 192. Alternatively, the plurality of flange attachment fasteners 190 may be a plurality of pins 194 extending from the interior surface 176 for pressing directly into the wall surface.

As illustrated in FIG. 4, the intumescent component 180 is positioned along the interior surface 130 of the cylindrical body 112. The intumescent component 180 may be a strip of intumescent material 182 that expands outward upon exposure to heat. The expanding intumescent material 182 then penetrates the plurality of perforations 134 extending into the interior wall space. The intumescent component 180 further expands inward upon exposure to heat. The inward expansion of the intumescent material fills a void created by the conduit when melted to completely seal any penetration in the wall.

The intumescent component 180 may also be positioned along the exterior surface 132 of the cylindrical body 112. The intumescent component 180 may also be a flange layer 186 positioned along the interior surface 176 of the flange component 150 to better cover the penetration in the wall created by the conduit as illustrated in FIG. 6. The intumescent component 190 is typically a firestopping caulk or strip of putty, although any type if intumescent material may be used. The intumescent material can be made in strips of varying thickness and widths. A strip of premade material would be the ideal form used in the fire barrier device 100. The intumescent component 190 may be an intumescent strip that is preconstructed and not moldable.

The fire barrier device 100 may further comprises a lip (not shown) at a bottom of the fire barrier device 100. The lip is configured to further hold the intumescent component 190 in place. This lip would serve to further direct the expanding material out of the holes in the sides of the fire barrier device 100 and not out of the end of the fire barrier device 100 that would be inside the wall.

As illustrated in FIG. 8, the subject matter disclosed and claimed herein, in one embodiment thereof, comprises a fire barrier system 200 of the present invention for protecting a wall system penetrated by a conduit. The fire barrier system 200 comprises a first fire barrier device 100 and a second fire barrier device 202. The first and second fire barrier devices 100 and 202 are each constructed identically to the fire barrier device 100 of the previous embodiment as illustrated in FIGS. 1-7. The first fire barrier device 100 is positional on one side of the wall system and the second fire barrier device 202 is positional on an opposing side of the wall system so that the conduit is completely encapsulated within the wall system.

The first barrier device 100 comprises a perforated conduit retaining component 110, a flange component 150, and an intumescent component 180. The perforated conduit retaining component 110 encapsulates a portion of the conduit within the wall system on a first side of the wall system as described supra.

The second barrier device 202 comprises a second perforated conduit retaining component (similar to 110), a second flange component (similar to 150), and a second intumescent component (similar to 180). The second perforated conduit retaining component encapsulates a portion of the conduit within the wall system on an opposite side of the wall system. The perforated conduit retaining components abut each other within the wall system to completely encapsulate the conduit within the wall system. Each intumescent component is configured to penetrate the respective perforated conduit retaining component when exposed to heat and to fill a void created by the conduit when melted.

It is contemplated that the fire barrier device 100 and system 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the foregoing, the fire barrier device 100 and system 200 of the present invention and its various structural components can be of any suitable size, shape, and configuration as is known in the art without affecting the overall concept of the invention, provided that it accomplishes the above stated objectives. One of ordinary skill in the art will appreciate that the shape and size of the fire barrier device 100 and system 200 and its various components and material, as shown in the FIGS. are for illustrative purposes only, and that many other shapes and sizes of the fire barrier device 100 and system 200 are well within the scope of the present disclosure. Although the dimensions of the fire barrier device 100 and system 200 are important design parameters, the fire barrier device 100 and system 200 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fire barrier device for protecting a wall system penetrated by a conduit, the fire barrier device comprising:
a conduit retaining component comprising a cylindrical body and a hinge, the cylindrical body comprising a first half and a second half connected along the hinge;
a flange component attached to a flange end of the cylindrical body; and
an intumescent component positioned along an interior surface of the cylindrical body; and
wherein the cylindrical body is positioned around and encapsulates a portion of the conduit within the wall system.

2. The fire barrier device of claim 1, wherein the cylindrical body further comprises a plurality of perforations.

3. The fire barrier device of claim 2, wherein the intumescent component penetrates the plurality of perforations when exposed to heat.

4. The fire barrier device of claim 1, wherein the first half comprises a receiving element for mating with an attachment element of the second half to encapsulate the conduit.

5. The fire barrier device of claim 1, wherein the intumescent component is a firestopping caulk.

6. The fire barrier device of claim 1, wherein the intumescent component is a firestopping putty.

7. The fire barrier device of claim 1, wherein the flange component comprises a first half and a second half.

8. The fire barrier device of claim 7, wherein an overlap portion of the first half slides behind an overlap portion of the second half when the first and second halves of the cylindrical body are opened along the hinge.

9. The fire barrier device of claim 1, wherein the flange component comprises a plurality of attachment holes.

10. The fire barrier device of claim 9 further comprising a plurality of flange attachment fasteners for attaching the flange component to a wall.

11. The fire barrier device of claim 1, wherein the intumescent component expands to fill a void created by the conduit when melted.

12. The fire barrier device of claim 1, wherein the intumescent component is further positioned along an interior surface of the flange component.

13. The fire barrier device of claim 1, wherein the intumescent component is further positioned along an exterior surface of the cylindrical body.

14. A fire barrier device for protecting a wall, a ceiling, or a floor of a building penetrated by a conduit, the fire barrier device comprising:
a conduit retaining component comprising a perforated cylindrical body and a hinge, the perforated cylindrical body comprising a first half and a second half connected along the hinge;
a flange component attached to a flange end of the perforated cylindrical body and attachable to the wall, the ceiling, or the floor; and
an intumescent component positioned along an interior surface of the perforated cylindrical body configured to penetrate the perforated cylindrical body when exposed to heat and to fill a void created by the conduit when melted; and
wherein the perforated cylindrical body is positioned around and encapsulates a portion of the conduit within the wall, the ceiling, or the floor.

15. The fire barrier device of claim 14, wherein the first half comprises a receiving element for mating with an attachment element of the second half to encapsulate the conduit.

16. The fire barrier device of claim 14, wherein the intumescent component is further positioned along an interior surface of the flange component.

17. The fire barrier device of claim 14, wherein the flange component comprises a first half and a second half, the first half comprising an overlap portion configured to slide behind an overlap portion of the second half when the first second halves of the perforated cylindrical body are opened along the hinge.

18. The fire barrier device of claim 17, wherein first half of the flange component further comprises an attachment element for mating with a receiving element of the second half of the flange component.

19. A fire barrier system for protecting a wall system penetrated by a conduit, the fire barrier system comprising:
a first fire barrier device comprising:
a perforated conduit retaining component for encapsulating a portion of the conduit within the wall system;
a flange component; and
an intumescent component; and
a second fire barrier device comprising:
a second perforated conduit retaining component for encapsulating a second portion of the conduit within the wall system;
a second flange component; and
a second intumescent component; and
wherein the first fire barrier device is positional on one side of the wall system and the second fire barrier device is positional on an opposing side of the wall system so that the conduit within the wall system is completely encapsulated within the perforated conduit retaining component and the second perforated conduit retaining component.

20. The fire barrier device of claim 18, wherein each intumescent component is configured to penetrate the respective perforated conduit retaining component when exposed to heat and to fill a void created by the conduit when melted.
